(19) United States
(12) Patent Application Publication
(10) Pub. No.: US 2010/0077415 A1
(43) Pub. Date: Mar. 25, 2010

(54) Chucking device for a disk

(75) Inventors: Young Sun Yoo, Gyunggi-do (KR); Yeol Choi, Gyunggi-do (KR); Ho Jun Yoo, Gyunggi-do (KR); Kyung Seob Shin, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/289,907

(22) Filed: Nov. 6, 2008

(30) Foreign Application Priority Data
Sep. 22, 2008 (KR) 10-2008-0092677

(51) Int. Cl. G11B 17/04

(52) U.S. Cl. 720/605; G9B/17.013

(57) ABSTRACT

A chucking device for a disk including a turntable on which an optical disk is seated, a housing provided on the turntable in such a manner as to be inserted into a center hole of the optical disk, a chuck pin having an end protruding outwards from the housing so that, when the optical disk is inserted into and released from the chuck pin, the chuck pin reciprocates from the center of the optical disk, a spring elastically forcing the end of the chuck pin outwards from the center of the optical disk, and a spring holder provided slantwise on the chuck pin such that the spring is held thereon so that an elastic force of the spring is applied inclined onto the chuck pin acting towards the direction of the turntable.

### CROSS REFERENCE TO RELATED APPLICATION

This application claims the benefit of Korean Patent Application No. 10-2008-0092677, filed on Sep. 22, 2008, entitled “Chucking Device for a Disk”, which is hereby incorporated by reference in its entirety into this application.

### BACKGROUND OF THE INVENTION

1. Field of the Invention

The present invention relates, in general, to a chucking device for a disk, and more particularly to a chucking device for a disk capable of increasing a chucking force for an optical disk while reducing a loading force for the optical disk.

2. Description of the Related Art

Generally, in an optical disk device for implementing a recording/reproducing operation on/from an optical disk such as compact disks (CDs), digital versatile disks (DVDs), blu-ray disks (BDs) or the like, a portable disk device has been widely developed in the related art as pertains to high density and high speed recording, reproducing and improvement in portability and an increase in the degree of temporal and spatial freedoms as a result of the demand for information.

One of important factors for such an optical disk device is to increase a chucking force for the optical disk so as to prevent the optical disk from slipping or deviating when the optical disk is loaded and rotates at high speed, while reducing a loading force required for loading the optical disk.

An example of a chucking device for loading/unloading an optical disk for satisfying the above condition is schematically illustrated in FIGS. 5 and 6.

As illustrated in FIGS. 5 and 6, a chucking device 300 according to the prior art includes a turntable 310, a housing 330, a chuck pin 340, and a spring 350.

The turntable 310 is provided for supporting an optical disk 320, and a rubber ring 311 is attached thereto in order to prevent the optical disk 320 from slipping when a spindle motor rotates at high speed.

The housing 330 includes therein the chuck pin 340 and the spring 350, and is inserted into a center hole of the optical disk 320 which is seated on the turntable.

The chuck pin 340 is provided for fixing the optical disk 320, wherein one end protrudes outwards and another end is inserted into the housing 330 such that it is compressed and slides in the housing 330.

The spring 350 is provided in the housing 330 for elastically supporting the chuck pin 340 in a direction opposite to the center direction of the optical disk 320.

In case the optical disk 320 is loaded in the chucking device 300 having the above construction, when the optical disk 320 is pressed downwards from an upper side of the housing 330, the chuck pin 340 coupled to the housing protrudes outwards, so that an edge of the center hole of the optical disk 320 comes into contact with an upper face of the chuck pin 340. Then, the chuck pin 340 compresses the spring 350 under the loading force of the optical disk 320 and is pushed inwards of the housing 330. Then, the bottom of the optical disk 320 is brought into contact with the rubber ring 311 of the turntable 310 thereby completing the loading of the optical disk 320, and at the same time, a lower face of the chuck pin 340 presses and fixes the upper edge of the center hole of the optical disk 320.

Meanwhile, in case the optical disk 320 is unloaded from the chucking device 300, an unloading force is applied to the optical disk 320, and the chuck pin 340 then is pushed into the housing 330 under the unloading force, thereby completing the unloading of the optical disk 320.

However, although in the chucking device 300, the chuck pin 340 is provided with upper and lower inclined surfaces in order to increase unloading force of the optical disk 320 while reducing the loading force, the loading force and an elastic force Fₛ of the spring 350 is in practice applied to the chuck pin 340, so that in order to load or unload the optical disk 320, the chuck pin 340 should be applied with a loading or unloading force greater than the elastic force Fₛ of the spring 350. It is very difficult to obtain a reduction in the loading force and an increase in the unloading force for the above reason.

That is, while in order to reduce the loading force for user's convenience, a spring 350 should have low elastic modulus, if such a spring 350 is used, the unloading force is reduced correspondingly, which causes deviation or slippage of the optical disk 320 upon high speedy rotation.

On the contrary, if a spring 350 with high elastic modulus is used in order to increase the unloading force of the optical disk 320 so as to prevent the deviation or slippage of the optical disk 320, the loading force of the optical disk increases correspondingly, which requires further force for loading the optical disk 320, eventually deteriorating convenience to the user.

### SUMMARY OF THE INVENTION

Accordingly, the present invention has been made in an effort to solve the aforementioned problems, and to reduce the loading force of an optical disk for the benefit of more convenience to the user and also increase the unloading force of the optical disk for securing a stable operating performance by employing a chucking device for a disk.

According to one aspect of the present invention, there is provided a chucking device for a disk including: a turntable on which an optical disk is seated; a housing provided on the turntable in such a manner as to be inserted into a center hole of the optical disk; a chuck pin having an end protruding outwards from the housing so that, when the optical disk is inserted into and released from the chuck pin, the chuck pin reciprocates from the center of the optical disk; a spring elastically forcing the end of the chuck pin in a direction opposite to the center of the optical disk; and a spring holder provided on the slant on the chuck pin such that the spring is held thereon so that an elastic force of the spring is applied inclined onto the chuck pin towards the turntable.

In the chucking device, the spring holder may have an inclined surface inclined towards the turntable from the center of the housing.

In the chucking device, a compressing force of the spring in the side of an upper portion of the spring holder may be larger than that of a lower portion of the spring holder.

In the chucking device, the elastic force of the spring applied to an upper portion of the spring holder may be larger than that applied to a lower portion of the spring holder, so that the elastic force applied to the chuck pin is directed in a slantwise manner towards the turntable.

In the chucking device, the loading force of the optical disk may satisfy F_{I}=Fₛ*cos ⊖, where F_{I} denotes the loading force of the optical disk, Fₛ denotes the elastic force applied on the slant onto the chuck pin, and ⊖ denotes an inclined angle of the elastic force to the turntable.

In the chucking device, the unloading force of the optical disk may satisfy F_{O}=Fₛ*(cos ⊖)+sin ⊖), where F_{O} denotes the unloading force of the optical disk, Fₛ denotes the elastic force applied on the slant onto the chuck pin, and ⊖ denotes an inclined angle of the elastic force to the turntable.

According to the chucking device for a disk of the present invention, the inclined face is provided on the portion of the chuck pin where the elastic force of the spring is applied so that the loading force of the optical disk is reduced while the unloading force of the optical disk is increased, thereby improving the user's convenience and securing stable operating performance.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic cross-sectional view illustrating a spindle motor on which a chucking device for a disk according to the present invention is installed;

FIGS. 2 and 3 are cross-sectional views illustrating the unloading/loading states of an optical disk in the chucking device for a disk;

FIG. 4 is a schematic cross-sectional view illustrating the elastic force of a spring, and the loading/unloading force of the optical disk, which are applied to a chuck pin of the chucking device of the invention;

FIG. 5 is a schematic cross-sectional view illustrating a spindle motor with a chucking device for a disk according to the prior art; and

FIG. 6 is a schematic cross-sectional view illustrating the elastic force of a spring applied to a chuck pin of the chucking device according to the prior art.

### DETAILED DESCRIPTION OF THE INVENTION

Reference will now be made in greater detail to a chucking device for a disk according to preferred embodiments of the invention, examples of which are illustrated in the accompanying drawings.

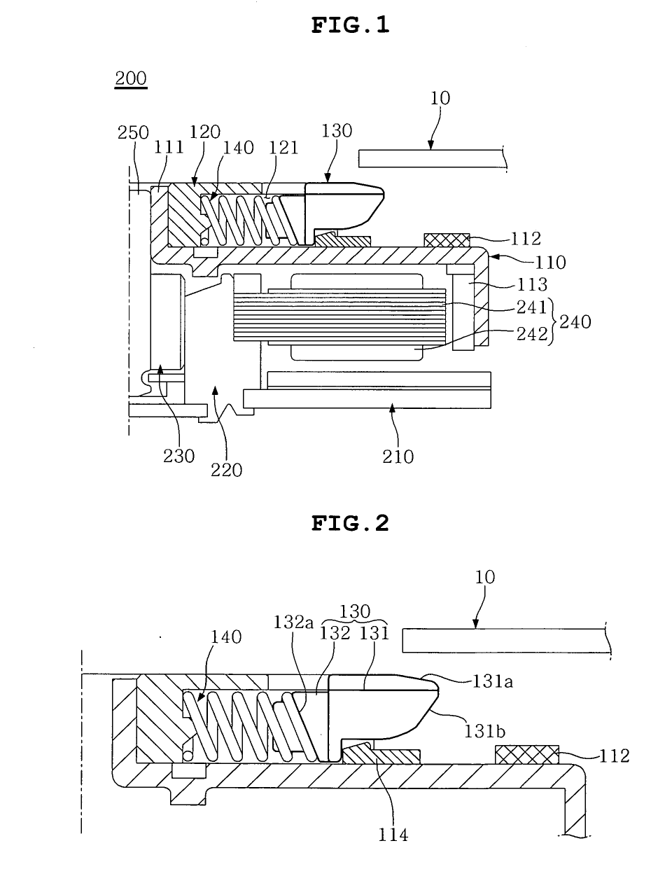

As illustrated in FIGS. 1 to 3, a chucking device 100 for a disk according to the invention is integrally installed on a spindle motor 200 so as to prevent deviation of an optical disk 10 when the spindle motor 200 rotates at high speed.

The spindle motor 200 is provided for loading and driving the optical disk 10, and includes a base 210, a bearing holder 220, a bearing 230, an armature 240, a rotating shaft 250, and a rotor case 110.

The base 210 is provided for supporting the whole of the spindle motor 200, and is fixedly installed on a device such as a hard disk driver or the like in which the spindle motor 200 is installed. The bearing holder 220 is of a hollow cylindrical shape so as to fixedly support the bearing 230, and an end thereof is calked or spun so that it is fixedly installed on the base 210. The bearing 230 is provided for rotatably supporting the rotating shaft 250, and a center axis thereof is aligned with that of the rotating shaft 250.

The armature 240 is provided for forming an electric field using external power, and consists of a core 241 and a coil 242 wound around the core 241, wherein, when the coil 242 is applied with external power, an electric field is created to thereby rotate the rotor case 110. The rotating shaft 250 is rotatably inserted and installed in an inner diameter of the bearing 230 so as to support the rotor case 110 upwards.

The rotor case 110 is provided on its inner circumferential surface with a magnet 113, which is fixedly provided opposite to the armature 240 to thereby creating a rotating force. On the rotor case 100, provided is the chucking device 100 for chucking the optical disk 10.

The chucking device 100 of the invention includes a turntable 110, a housing 120, a chuck pin 130, and a spring 140, which are integrated with the spindle motor 200.

The turntable 110 is provided for supporting the optical disk 10, and in the present embodiment, the rotor case 110 of the spindle motor 200 is used as the turntable. The turntable 110 includes a center connection holder 111 in which the rotating shaft 250 is fixedly inserted and connected.

The turntable 110 is provided with a rubber ring 112 along an outer peripheral edge thereof so as to prevent the slippage of the optical disk 10 when the spindle motor 200 rotates at high speed.

The housing 120 is provided for housing the chuck pin 130 and the spring 140, and is inserted into a center hole of the optical disk 10 such that it covers the connection holder 111 in the center of the turntable 110.

Further, the housing 120 includes a plurality of receiving holes 121 at regularly spaced distances from the center thereof so as to respectively receive therein the chuck pin 130 and the spring 140. It is preferred that three receiving holes 121 be provided in the housing 120 such that they are arranged separated 60 degrees apart from one another as measured from the center of the housing 120.

The chuck pin 130 is provided for fixing the optical disk 10, and elastically reciprocates in the receiving hole 121. One end of the chuck pin protrudes outwards from the housing, and another end thereof is inserted into the receiving hole 121 of the housing 120 so that it is elastically supported by the spring 140.

Here, the chuck pin 130 consists of a protrusion 131 protruding outwards from the housing 120, and a spring holder 132 on which the spring 140 is held. The chuck pin will be described in detail with reference to FIG. 2.

The spring 140 is provided for elastically supporting the chuck pin 130 in a direction outwards from the center of the optical disk 10, wherein an end thereof is fixedly coupled to the receiving hole 121 of the housing 120, and another end thereof is fixedly held on the spring holder 132 of the chuck pin 130.

As shown in FIG. 2, the chuck pin 130 has the protrusion 131, which presses and fixes the optical disk 10, and the spring holder 132 provided in the rear side of the protrusion 131 such that the spring is closely held thereon.

The protrusion 131 has upper and lower inclined surfaces 131a and 131b, which closely abut against an edge of the center hole of the optical disk 10, in order to facilitate loading/unloading of the optical disk 10. The protrusion 131 is supported by a supporting step 114 at its lower end, so as to prevent the chuck pin 130 from escaping outwards from the housing 120 by means of an elastic force Fₛ of the spring 140.

The spring holder 132 is provided in a slanting orientation so that the elastic force Fₛ of the spring 140 is directed towards the turntable 110. Particularly, the spring holder is provided with an inclined surface 132a such that the elastic force of the spring 140 is directionally applied to the chuck pin 130, that is, the elastic force applied to an upper portion of the spring holder 132 is larger than that applied to a lower portion of the spring holder 132.

Like this, the spring holder 132 having the inclined surface 132a facing the turntable 110 allows the spring to exert the elastic force Fₛ in a slantwise manner onto the chuck pin 130 acting towards the turntable 110, so that the loading force F_{I} of the optical disk 10 is reduced, and the unloading force F_{O} of the optical disk is increased. This will be described in detail with reference to FIG. 4.

As shown in FIG. 4, the elastic force Fₛ of the spring 140 is applied to the chuck pin 130. That is, since the inclined surface 132a of the spring holder 132 is inclined towards the turntable 110, and a compressing force of the spring 140 in the side of the upper portion of the inclined surface 132a is larger than that in the side of the lower portion of the inclined surface 132a, a larger elastic force is applied to the upper portion of the inclined surface 132a, so that the elastic force Fₛ of the spring is directionally applied to the chuck pin 130 in a direction acting towards the turntable 110.

Here, a horizontal component Fₕ and a vertical component Fᵥ of the elastic force Fₛ applied to the upper portion of the housing 120 or the turntable 110 can be expressed by the following equation 1.

Fₕ=Fₛ*cos ⊖, Fᵥ=Fₛ*sin ⊖ [Equation 1]

where ⊖ denotes an inclined angle of the elastic force Fₛ.

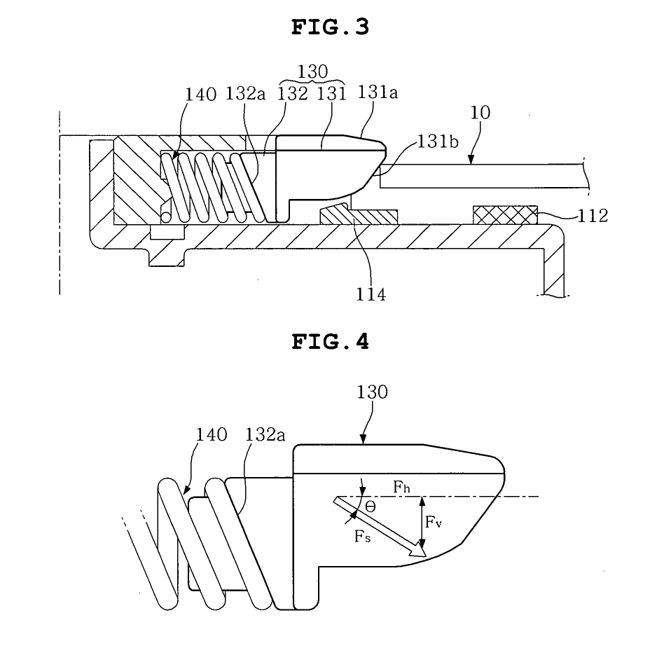

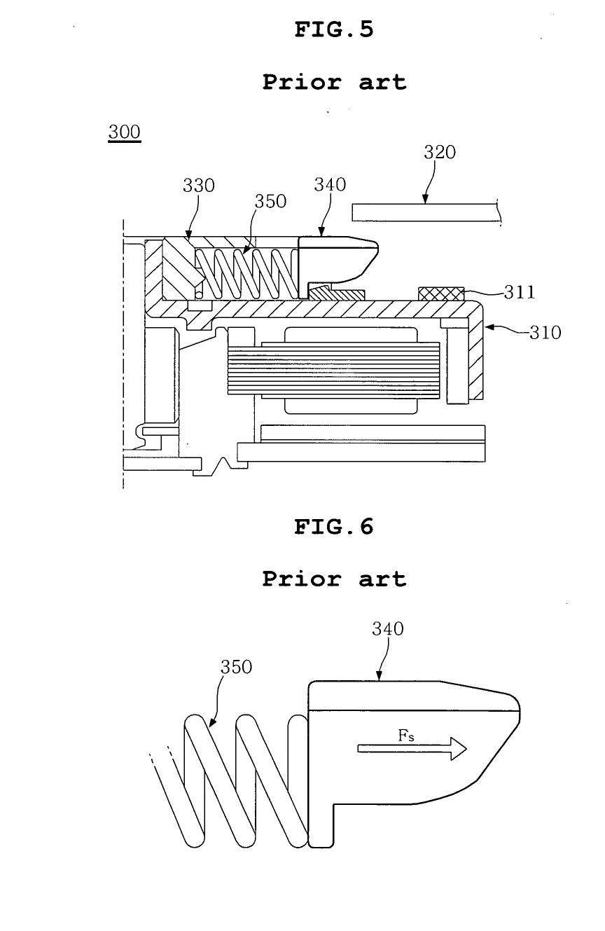

Because of the inclined surface 132a of the spring holder 132, inclined elastic force Fₛ is applied to the chuck pin 130, and the optical disk 10 is loaded and unloaded in and from the chucking device 100 as illustrated in FIGS. 2 and 3.

As illustrated in FIG. 2, the optical disk 10 is loaded in the chucking device in a direction pressing the chuck pin 130, wherein the optical disk 10 can be loaded with a loading force F_{I} equal to or slightly larger than the horizontal component Fₕ of the elastic force Fₛ of the spring.

That is, in the present embodiment, the loading force F_{I} of the optical disk 10 can be expressed by the following equation 2.

F_{I}=Fₛ*cos ⊖ [Equation 2]

Thus, as compared to the chucking device of the prior art (F_{I}=Fₛ), the loading force F_{I} becomes reduced. That is, if a spring 140 having the same elastic modulus as in the prior art is used in order to load the optical disk, according to the prior art, the optical disk should be applied with a loading force equal to or larger than the elastic force Fₛ of the spring, whereas according to the present embodiment, the optical disk 10 can be loaded even with a reduced loading force F_{I} by cos ⊖. Further, the optical disk 10 can be loaded even with a loading force F_{I} which is reduced by the vertical component Fᵥ of the elastic force Fₛ.

As illustrated in FIG. 3, the optical disk, which has been pressed and fixed by the chuck pin 130, is unloaded. To unload the optical disk 10, a unloading force F_{O} should be applied which corresponds to a resultant force of the horizontal component Fₕ and the vertical component Fᵥ of the elastic force Fₛ. That is, unlike the prior art, the optical disk 10 is further applied with the vertical component Fᵥ pressing the optical disk 10, acting towards the turntable 110, in addition to the horizontal component Fₕ of the elastic force Fₛ, so that the unloading force F_{O} for unloading the optical disk 10 can be expressed by the following equation 3.

F_{O}=Fₛ*cos ⊖+Fₛ*sin ⊖=Fₛ*(cos ⊖+sin ⊖) [Equation 3]

Here, since cos ⊖+sin ⊖>1, the chucking device 100 of the present embodiment has an improved unloading force F_{O} relative to the prior chucking device wherein F_{O}=Fₛ. That is, if the spring 140 having the same elastic modulus as that of the prior art is used, since the unloading force F_{O} of the optical disk 10 is increased by the vertical component Fᵥ pressing the optical disk 10, the optical disk 10 can be prevented from deviating or slipping.

According to the chucking device 100 having the above construction, when only an inclined angle of the inclined surface 132a of the spring holder 132 of the chuck pin 130 is regulated without changing the elastic modulus of the spring 140, the loading force of the optical disk 10 can be reduced while the unloading force of the optical disk 10 can be increased.

The foregoing invention has been described with respect to the chucking device for a disk in terms of preferred embodiments. However, those skilled in the art will appreciate that various modifications, additions and substitutions are possible, without departing from the scope and spirit of the invention as disclosed in the accompanying claims.

What is claimed is:

1. A chucking device for a disk comprising:
a turntable on which an optical disk is seated;
a housing provided on the turntable in such a manner as to be inserted into a center hole of the optical disk;
a chuck pin having an end protruding outwards from the housing so that, when the optical disk is inserted into and released from the chuck pin, the chuck pin reciprocates from the center of the optical disk;
a spring elastically forcing the end of the chuck pin in a direction outwards from the center of the optical disk; and
a spring holder provided slantwise on the chuck pin such that the spring is held thereon so that an elastic force of the spring is applied in an inclined manner onto the chuck pin acting towards the turntable.

2. The chucking device according to claim 1, wherein the spring holder has an inclined surface inclined towards the turntable from the center of the housing.

3. The chucking device according to claim 1, wherein a compressing force of the spring in the side of an upper portion of the spring holder is larger than that of a lower portion of the spring holder.

4. The chucking device according to claim 1, wherein the elastic force of the spring applied to an upper portion of the spring holder is larger than that applied to a lower portion of the spring holder, so that the elastic force applied to the chuck pin is directed on the slant towards the turntable.

5. The chucking device according to claim 1, wherein the loading force of the optical disk satisfies F_{I}=Fₛ*cos ⊖, where F_{I} denotes the loading force of the optical disk, Fₛ denotes the elastic force applied slantwise onto the chuck pin, and ⊖ denotes an inclined angle of the elastic force to the turntable.

6. The chucking device according to claim 1, wherein the unloading force of the optical disk satisfies F_{O}=Fₛ*(cos ⊖+sin ⊖), where F_{O} denotes the unloading force of the optical disk, Fₛ denotes the elastic force applied slantwise onto the chuck pin, and ⊖ denotes an inclined angle of the elastic force to the turntable.
